(19) United States
(12) Patent Application Publication
(10) Pub. No.: US 2011/0133669 A1
(43) Pub. Date: Jun. 9, 2011

(54) LIGHT EMITTING DIODE DRIVING DEVICE

(75) Inventors: CHIH-CHAN GER, Jhongli City (TW); CHIA-KUN CHEN, Jhongli City (TW)

(73) Assignee: AMPOWER TECHNOLOGY CO., LTD., Jhongli City (TW)

(21) Appl. No.: 12/844,832

(22) Filed: Jul. 28, 2010

(30) Foreign Application Priority Data
Dec. 3, 2009 (CN) 200920316470.3

(51) Int. Cl. H05B 41/36

(52) U.S. Cl. 315/294

(57) ABSTRACT

A light emitting diode (LED) driving device for driving a plurality of LED strings includes a power stage circuit, a plurality of fly-back transformers, and a controller circuit. The power stage circuit outputs direct current (DC) voltage signals. Each of the plurality of fly-back transformers includes a primary winding connected to the power stage circuit and a secondary winding connected to a diode and one of the plurality of LED strings to form a series loop. The controller circuit controls the plurality of fly-back transformers to synchronously work in a discontinuous current mode to make the plurality of LED strings have the same current.

### BACKGROUND

1. Technical Field

The disclosure relates to backlight driving devices, and particularly to a light emitting diode driving device.

2. Description of Related Art

The number of backlights of screens of electronic devices, such as light emitting diodes (LEDs), increase with increasing sizes of the screens. Therefore, there is a need for large transformers to provide enough driving voltage to the LEDs. Meanwhile, current balancing circuits are needed to balance current flowing through the LEDs to insure brightness uniformity of the screens. However, the utilization of the large transformers and the current balancing circuits result in the electronic devices having large sizes.

### BRIEF DESCRIPTION OF THE DRAWINGS

FIG. 1 is a schematic diagram of one embodiment of a light emitting diode driving device as disclosed.

FIG. 2 is a schematic diagram of another embodiment of a light emitting diode driving device as disclosed.

### DETAILED DESCRIPTION

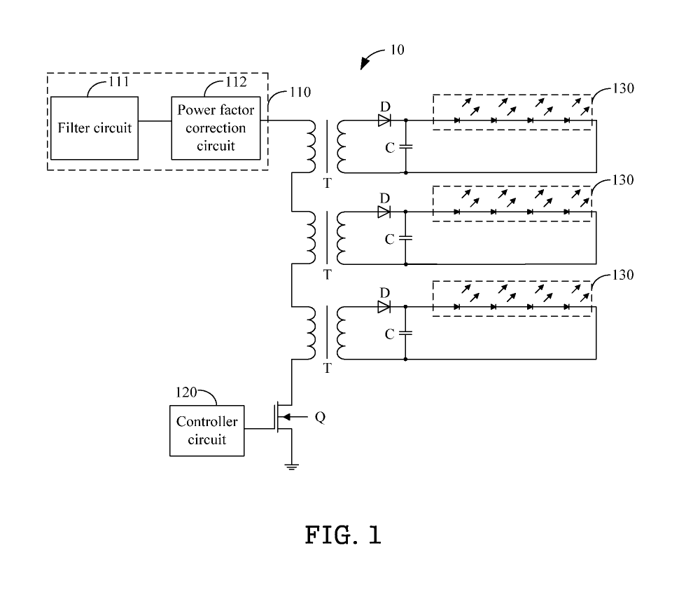

FIG. 1 is a schematic diagram of one embodiment of a light emitting diode (LED) driving device 10 as disclosed. The LED driving device 10 drives a plurality of LED strings 130, and includes a power stage circuit 110, a controller circuit 120, a plurality of fly-back transformers T, and a switch element Q. Each of the plurality of LED strings 130 includes a plurality of LEDs connected in series having the same forward voltage.

The power stage circuit 110 outputs direct current (DC) voltage signals to the plurality of fly-back transformers T. In one embodiment, the power stage circuit 110 includes a filter circuit 111 and a power factor correction circuit 112. The filter circuit 111 filters external alternating current (AC) voltage signals into the DC voltage signals. The power factor correction circuit 112 corrects power factor of the DC voltage signals. In alternative embodiments, external DC power source directly provides DC voltage signals to the plurality of fly-back transformers T.

In one embodiment, the plurality of fly-back transformers T have same electrical characteristics, for example, turn ratios and inductance of primary windings and secondary windings. The primary windings of the plurality of fly-back transformers T are connected in series to receive the DC voltage signals from the power stage circuit 110. That is, a high voltage terminal of the primary winding of a first one of the plurality of fly-back transformers T is connected to the power stage circuit 110, and a low voltage terminal of the primary winding of a previous one of the plurality of fly-back transformers T is connected to a high voltage terminal of the primary winding of a latter one of the plurality of fly-back transformers T. The secondary winding of each of the plurality of fly-back transformers T is connected to a diode D and one LED string 130 in series, forming a series loop. An anode of the diode D is connected to a high voltage terminal of the secondary winding of the corresponding fly-back transformer T, and a cathode of the diode D is connected to an anode of a first LED of the corresponding LED string 130. In one embodiment, the LED driving device 10 further includes a plurality of capacitors C, and each of the plurality of capacitors C is connected to one of the plurality of LED strings 130 in parallel to stable the driving voltage of the corresponding LED string 130.

The controller circuit 120 controls the plurality of fly-back transformers T to synchronously work in a discontinuous current mode to make the plurality of LED strings 130 have the same current. That is, in each on/off cycle, the energy of the primary windings of the plurality of fly-back transformers T has been transferred to corresponding secondary windings completely in each off period. The current flowing through the primary windings of the plurality of fly-back transformers T are start from zero in each on period. In one embodiment, the switch element Q is connected to the primary windings of the plurality of fly-back transformers T in series, and are turned on or off according to control signals output by the controller circuit 120. Thus the switch element Q controls current to synchronously flow through the primary windings of the plurality of fly-back transformers T or to synchronously stop flowing, which implements that the plurality of fly-back transformers T synchronously work in discontinuous current mode.

The controller 120 may be a pulse width modulation (PWM) controller. Turned on/off periods of the switch element Q can be adjusted by adjusting duty cycles of PWM signals of the PWM controller, and operating frequency of the switch element Q can also be controlled by the adjusting frequency of the PWM signals. In one embodiment, the switch element Q may be a metal oxide semiconductor field effect transistor including a drain pole connected to a low voltage terminal of the primary winding of a last one of the plurality of fly-back transformers T, a source pole grounded, and a gate pole connected to the controller circuit 120.

In one embodiment, power P transmitted by each of the plurality of fly-back transformers T is calculated according to a formula of P=1/(2LI²F), where I is current flowing through the primary winding of each of the plurality of fly-back transformers T, L is inductance of the primary winding of each of the plurality of fly-back transformers T, and f is turned on/off frequency of the switch element Q. Because the plurality of fly-back transformers T have same inductance and are connected in series, current flowing through the primary winding of each of the plurality fly-back transformers T is the same when the controller circuit 120 controls the switch element Q to turn on. Thus, the power P transmitted from the primary windings to the secondary windings of the plurality of fly-back transformers T is the same. In addition, the plurality of LED strings 130 have the same forward voltage, so current flowing through the plurality of LED strings 130 is the same. That is, the plurality of LED strings 130 have same brightness.

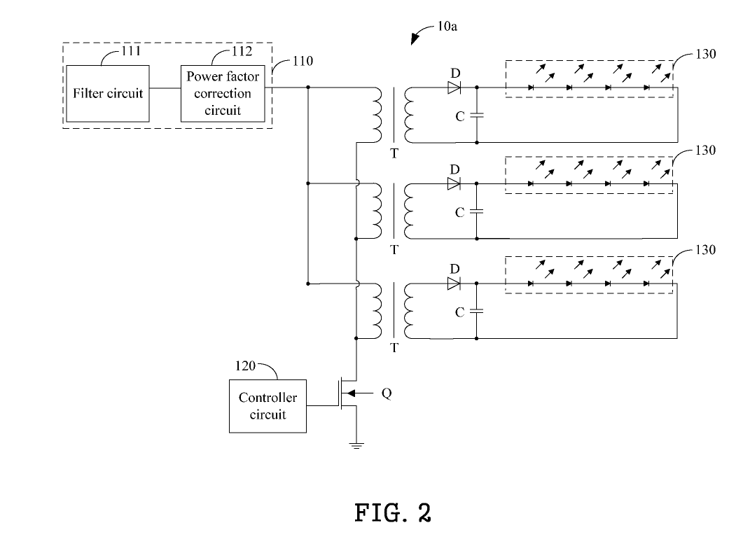

FIG. 2 is a schematic diagram of another embodiment of a LED driving device 10a as disclosed. The LED driving device 10a has similar structures and connections to those of the LED driving device 10 in FIG. 1 except the connection of the primary windings of the plurality of fly-back transformers T. As shown in FIG. 2, the primary windings of the plurality of fly-back transformers T are connected in parallel. The high voltage terminals of the primary windings of the plurality of fly-back transformers T are all connected to the power stage circuit 110, the low voltage terminals of the primary windings of the plurality of fly-back transformers T are all connected to the drain pole of the switch element Q. Descriptions of other structures and connections of the LED driving device 10a similar to those of FIG. 1 are omitted here.

In this embodiment, power P transmitted by each of the plurality of fly-back transformers T is also calculated according to the formula of P=1/(2LI²F). Where I is current flowing through the primary winding of each of the plurality of fly-back transformers T, and is calculated according to a formula of d(I)=Vdt/L. L is inductance of the primary winding of each of the plurality of fly-back transformers T, f is turned on/off frequency of the switch element Q, and V is voltage of the primary winding of each of the plurality of fly-back transformers T. Because the plurality of fly-back transformers T have same inductance and are connected in parallel, voltages on the primary winding of each of the plurality fly-back transformers T is the same when the controller circuit 120 controls the switch element Q to turn on. Thus, current flowing through the primary winding of each of plurality of fly-back transformers T is the same, and the power transmitted from the primary windings to the secondary windings of the plurality of fly-back transformers T is the same. In addition, the plurality of LED strings 130 have the same forward voltage, so current flowing through the plurality of LED strings 130 is the same. That is, the plurality of LED strings 130 have same brightness.

The LED driving devices 10 and 10a make the plurality fly-back transformers T work in discontinuous current mode to drive the plurality of LED strings 130 with balanced current, which reduces sizes of transformers and avoids utilization of current balancing circuits. Thus, miniaturization of electronic devices can be achieved.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A light emitting diode (LED) driving device, for driving a plurality of LED strings, each LED string comprising a plurality of LEDs connected in series, the LED driving device comprising:
a power stage circuit, operable to output direct current (DC) voltage signals;
a plurality of fly-back transformers, each of the plurality of fly-back transformers comprising a primary winding connected to the power stage circuit and a secondary winding connected to a diode and one of the plurality of LED strings in series; and
a controller circuit, operable to control the plurality of fly-back transformers to synchronously work in a discontinuous current mode to make the plurality of LED strings have the same current.

2. The LED driving device of claim 1, wherein the primary windings of the plurality of fly-back transformers are connected in series.

3. The LED driving device of claim 2, further comprising a switch element connected to the primary windings of the plurality of fly-back transformers in series and turned on or off according to control signals output by the controller circuit.

4. The LED driving device of claim 3, wherein the switch element is a metal oxide semiconductor field effect transistor comprising a drain pole connected to the primary windings of the plurality of fly-back transformers, a source pole grounded, and a gate pole connected to the controller circuit.

5. The LED driving device of claim 1, wherein the primary windings of the plurality of fly-back transformers are connected in parallel.

6. The LED driving device of claim 5, further comprising a switch element connected to the primary windings of the plurality of fly-back transformers in series and turned on or off according to control signals output by the controller circuit.

7. The LED driving device of claim 6, wherein the switch element is a metal oxide semiconductor field effect transistor comprising a drain pole connected to the primary windings of the plurality of fly-back transformers, a source pole grounded, and a gate pole connected to the controller circuit.

8. The LED driving device of claim 1, further comprising a plurality of capacitors, wherein each of the plurality of capacitors is connected to one of the plurality of LED strings in parallel.

9. The LED driving device of claim 1, wherein the controller circuit is a pulse width modulation controller.

10. The LED driving device of claim 1, wherein the plurality of LED strings have same forward voltage.

11. The LED driving device of claim 1, wherein the plurality of fly-back transformers have same electrical characteristics.

12. The LED driving device of claim 1, wherein the power stage circuit comprises:
a filter circuit, operable to filter external alternating current voltage signals into DC voltage signals; and
a power factor correction circuit, operable to correct power factor of the DC voltage signals.
